(19) United States
(12) Patent Application Publication
(10) Pub. No.: US 2023/0072849 A1
(43) Pub. Date: Mar. 9, 2023

(54) SEAT CONTROL DEVICE AND SEAT CONTROL METHOD

(71) Applicant: Hidekazu IMAI, Aichi (JP)

(72) Inventor: Hidekazu IMAI, Aichi (JP)

(73) Assignee: NIDEC MOBILITY CORPORATION, Aichi (JP)

(21) Appl. No.: 17/939,955

(22) Filed: Sep. 8, 2022

(30) Foreign Application Priority Data
Sep. 9, 2021 (JP) 2021-146651

(51) Int. Cl. B60N 2/02

(52) U.S. Cl. CPC B60N 2/0244; B60N 2/0232

(57) ABSTRACT

To prevent the occurrence of pinching again at another place due to a seat that reversely moves at the time of occurrence of pinching, and shorten the time until the seat that has stopped after the reverse movement moves to a target position. When the seat control device detects that pinching has occurred while the seat moves from the operation start position to the target position, the seat control device rotates the motor backward to move the seat from the pinching position in the reverse direction by the reverse movement amount. In this case, when the seat movement amount from the operation start position to the pinching position is larger than a predetermined reference value, the seat is moved to the reverse position using the reference value as the reverse movement amount. The reverse position is a position that does not exceed the operation start position.

### CROSS-REFERENCE TO RELATED APPLICATION

This application is based on Japanese Patent Application No. 2021-146651 filed with the Japan Patent Office on Sep. 9, 2021, the entire contents of which are incorporated herein by reference.

### FIELD

The disclosure relates to a device for controlling an electric seat mounted on a vehicle or the like, and more particularly to a seat control device having a function of detecting pinching of foreign matter.

### BACKGROUND

Some vehicles such as a four-wheeled automobile are equipped with an electric seat that moves back and forth by rotation of a motor. Conventionally, the seat position is adjusted by manually moving the seat forward or backward by operating an operation unit provided near the seat. On the other hand, in recent years, a vehicle having an automatic drive function has appeared. In the vehicle, a seat position matching a user's preference is registered in advance as a target position, and the seat automatically moves to the target position at the time of boarding.

In a vehicle having such an automatic drive function, for example, when a front seat automatically moves backward in a state where a person or an object is present between a front seat and a rear seat, the person or the object may be caught between the front and rear seats, and safety may be threatened. For this reason, the seat control device is required to have a function of, when pinching occurs, detecting the occurrence of the pinching and rotating the motor backward to reversely move the seat forward to eliminate the pinching.

When pinching occurs, the current flowing through the motor increases and the rotational speed of the motor decreases as the load applied to the motor increases. Therefore, it is possible to determine whether pinching has occurred by detecting the amount of change (difference) in the current or the rotational speed of the motor in a predetermined period and comparing the detected value with a threshold value. Korean Patent Publication No. 10-2020 0065312, Korean Patent Publication No. 10-2020 0065302, Korean Patent Publication No. 10-2013 0039104, Chinese Patent Publication No. 109278594, Japanese Patent Application Laid-Open No. 2016-129449, and Japanese Patent Application Laid-Open No. 2007-131138 disclose techniques of pinching detection in position control of a seat.

Dissolution of pinching by rotating a motor backward at the time of occurrence of pinching has been conventionally performed also in a power window device that electrically opens and closes a window (for example, Japanese Patent Application Laid-Open No. 2016-142068). In the case of the power window device, when pinching occurs in the process of raising and closing the window, the window is reversed and lowered, but the reverse movement amount at this time is always constant. In addition, since the window is in an open state while the window is reversely moved, pinching does not occur again. On the other hand, in the case of pinching by a seat, the situation is different. Hereinafter, a specific description will be given.

FIGS. 10A to 10C illustrate states of pinching occurring in the sliding operation in which the seat moves straightforward and backward. FIG. 10A illustrates a state before a sliding operation, a seat 30 in the front seat (the driver's seat in this example) on which an occupant 50 is seated is located at a position separated by a certain distance from a rear seat 40 on which an occupant 60 is seated. The seat 30 includes a seat portion 31 that can go straight forward and backward, and a backrest portion 32 that can be inclined forward and backward.

When the occupant 50 performs an operation of automatically moving the seat 30 to a target position M1 in this state, the seat portion 31 of the seat 30 moves in the P direction (rearward) toward the target position M1 as illustrated in FIG. 10B. At this time, for example, when the target position M1 is set at a position close to the rear as illustrated in the drawing in order to secure a sufficient space in the driver's seat, a part of the moving seat 30 hits the legs of the occupant 60 in the rear seat as indicated by a broken line a. Therefore, the seat 30 cannot move any more, and the legs are pinched between the seats 30 and 40. When this pinching is detected, the motor is rotated backward, and the seat 30 is reversed from the pinching position in FIG. 10B and moves in the Q direction (forward) illustrated in FIG. 10C. As a result, the pinching of the legs of the occupant 60 is eliminated.

However, the movement amount (reverse movement amount) of the seat 30 after the reverse only needs to be a movement amount sufficient to eliminate the pinching, and does not need to be a constant or more movement amount at all times. On the contrary, when the reverse movement amount is larger than necessary, the forward movement distance of the seat 30 becomes long, and as indicated by a broken line b in FIG. 10C, the legs of the occupant 50 in the front seat are pinched between a dashboard 70 and the seat 30. This is a problem peculiar to the seat control device, which is not found in the power window device. Further, when the seat 30 stopped after the reverse is moved again from the position of FIG. 10C to the target position M1, there is a problem that it takes time due to a long movement distance.

Problems similar to these problems also exist in a reclining operation in which the seat is inclined forward and backward. FIGS. 11A to 11C illustrate states of pinching in this case. FIG. 11A illustrates a state before the reclining operation, and the backrest portion 32 of the seat 30 is located away from a cargo 80 placed between both seats 30 and 40 before the reclining operation.

When the occupant 50 performs an operation of automatically inclining the seat 30 to the target position M2 in this state, the backrest portion 32 of the seat 30 is inclined in the P direction (rearward) toward the target position M2 as illustrated in FIG. 11B. At this time, when the inclination amount to the target position M2 is large, as indicated by a broken line c, the backrest portion 32 comes into contact with the cargo 80 and cannot be further inclined, and the cargo 80 is pinched between both seats 30 and 40. When this pinching is detected, the motor is rotated backward, and the backrest portion 32 is reversed from the pinching position in FIG. 11B and inclined in the Q direction (forward) illustrated in FIG. 11C. Accordingly, the pinching of the cargo 80 is eliminated.

However, also in this case, the movement amount (reverse movement amount) of the backrest portion 32 after the reverse only needs to be a sufficient movement amount for eliminating the pinching, and does not need to be a constant movement amount or more at all times. On the contrary, when the reverse movement amount is larger than necessary, the forward movement distance of the backrest portion 32 becomes long, and as indicated by a broken line d in FIG. 11C, a situation in which the occupant 50 is pinched between a steering wheel 90 and the backrest portion 32 occurs. Further, even when the seat 30 stopped after the reverse is moved again from the position of FIG. 11C to the target position M2, there is a problem that it takes time because the movement distance is long.

### SUMMARY

An object of the disclosure is to prevent the occurrence of pinching again at another place due to a seat that reversely moves at the time of occurrence of pinching, and shorten the time until the seat that has stopped after the reverse movement moves to a target position.

A seat control device according to the disclosure is a seat control device having a function of automatically moving an electric seat moved by rotation of a motor from an operation start position to a target position, the seat control device, and includes a pinching detector and a motor controller. The pinching detector detects pinching of an object while the seat is moving to the target position. The motor controller rotates the motor forward to move the seat to the target position, and when the pinching detector detects pinching of the object, rotates the motor backward to move the seat by a predetermined reverse movement amount in a reverse direction from a pinching position where the pinching has occurred.

In a first aspect of the disclosure, a seat movement amount from the operation start position to the pinching position is compared with the reference value. When the seat movement amount is equal to or larger than the reference value, the reference value is set as the reverse movement amount, and the seat is moved in the reverse direction. On the other hand, when the seat movement amount is less than the reference value, the seat is moved in the reverse direction with the seat movement amount as the reverse movement amount.

In a second aspect of the disclosure, the reverse movement amount is a value smaller than the seat movement amount from the operation start position to the pinching position, and the seat moving in the reverse direction stops before reaching the operation start position.

In the disclosure, since the reverse movement amount is limited so that the seat reversed at the pinching position does not move beyond the operation start position, it is possible to avoid occurrence of pinching at another place by the seat after the reverse. In addition, since the seat after the reverse stops at a position not exceeding the operation start position, the time for moving the seat from the position to the target position can be shortened.

The seat control device of the disclosure may further include a first switch configured to operate when the seat is automatically moved to the target position. In this case, after the seat moves in the reverse direction and stops, the motor controller rotates the motor forward to move the seat to the target position based on the operation of the first switch.

The seat control device of the disclosure may further include a second switch configured to operate when the seat is manually moved. In this case, the motor controller rotates the motor forward based on the operation of the second switch after the seat moves in the reverse direction and stops, and moves the seat in a direction of the target position while the second switch is operated.

In the seat control device of the disclosure, when the seat is a seat portion having a seat portion capable of moving straight forward and backward, the seat movement amount is a movement distance of the seat portion. When the seat is a seat having a backrest portion inclinable forward and backward, the seat movement amount is an inclination angle of the backrest portion.

According to the disclosure, it is possible to prevent the occurrence of pinching again at another place due to the seat that reversely moves at the time of occurrence of pinching, and it is possible to shorten the time until the seat that has stopped after the reverse movement moves to the target position.

### BRIEF DESCRIPTION OF THE DRAWINGS

FIG. 1 is a block diagram of an electric seat system including a seat control device according to a first embodiment of the disclosure;

FIG. 2 is a diagram for explaining an operation of a seat in a normal state;

FIG. 3 illustrates diagrams (A) and (B) for explaining operations (Pattern 1) at the time of occurrence of pinching;

FIG. 4 illustrates diagrams (A) and (B) for explaining operations (Pattern 2) at the time of occurrence of pinching;

FIG. 5 is a diagram for explaining movement of a seat from a reverse position to a target position;

FIG. 6 is a flowchart illustrating a procedure in a seat control device for executing the operations of Pattern 1 and Pattern 2;

FIG. 7 illustrates diagrams (A) and (B) for explaining operations (Pattern 3) at the time of occurrence of pinching;

FIG. 8 is a flowchart illustrating a procedure in a seat control device for executing the operation of Pattern 3;

FIG. 9 is a block diagram of an electric seat system including a seat control device according to a second embodiment of the disclosure;

FIGS. 10A to 10C are diagrams for explaining pinching in a sliding operation of the seat; and

FIGS. 11A to 11C are diagrams for explaining pinching in a reclining operation of the seat.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

Some embodiments of the disclosure will be described with reference to the drawings. In the drawings, the same portions or corresponding portions are denoted by the same reference numerals. Hereinafter, a seat control device mounted on a vehicle will be described as an example.

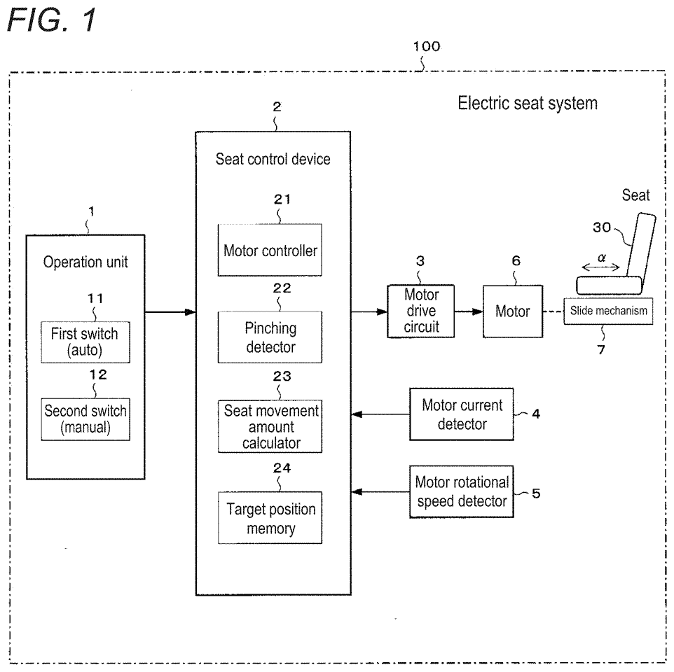

FIG. 1 illustrates an example of a seat control device 2 according to a first embodiment of the disclosure and an electric seat system 100 using the same. The electric seat system 100 is mounted on a vehicle such as a four-wheeled automobile, and includes an operation unit 1, a seat control device 2, a motor drive circuit 3, a motor current detector 4, a motor rotational speed detector 5, a motor 6, a slide mechanism 7, and a seat 30. The seat 30 is an electric seat driven by the motor 6 and the slide mechanism 7.

The operation unit 1 includes a first switch 11 for automatic driving that is operated when the seat 30 is automatically moved to a target position, and a second switch 12 for manual driving that is operated when the seat 30 is manually moved to an arbitrary position. The first switch 11 is provided, for example, inside the door of the driver's seat, and the second switch 12 is provided, for example, on the side of the seat 30.

The seat control device 2 includes a motor controller 21, a pinching detector 22, a seat movement amount calculator 23, and a target position memory 24. The motor controller 21 outputs a control signal for controlling the rotation of the motor 6 to the motor drive circuit 3 based on the operation state of each of the switches 11 and 12 of the operation unit 1, the detection result of the pinching detector 22, the seat movement amount calculated by the seat movement amount calculator 23, and the like.

The pinching detector 22 detects pinching of an object (a person's leg, baggage, or the like) by the seat 30 based on the current of the motor 6 detected by the motor current detector 4. Since details of the pinching detection based on the motor current are well known, description thereof will be omitted.

The seat movement amount calculator 23 calculates the movement amount of the seat 30 based on the rotational speed of the motor 6 detected by the motor rotational speed detector 5. The movement amount in this case is a movement distance of the seat 30. The motor rotational speed detector 5 includes, for example, a rotation sensor that outputs a pulse signal in synchronization with the rotation of the motor 6.

In the target position memory 24, a target position when the seat 30 is automatically driven by the first switch 11 is set. After the position of the seat 30 is adjusted to a desired position by operating the second switch 12, the position is stored as a target position in the target position memory 24 by operating a setting switch (not illustrated).

The seat control device 2 includes a microcomputer, and the functions of the motor controller 21, the pinching detector 22, and the seat movement amount calculator 23 are actually implemented by software, but are illustrated as hardware blocks for convenience.

The motor drive circuit 3 generates a drive voltage for rotating the motor 6 and supplies the drive voltage to the motor 6. The motor 6 rotates by the drive voltage to move the seat 30 in the front-rear direction (a direction) via the slide mechanism 7. The slide mechanism 7 is connected to the motor 6 and the seat 30, and converts rotational motion of the motor 6 into linear motion.

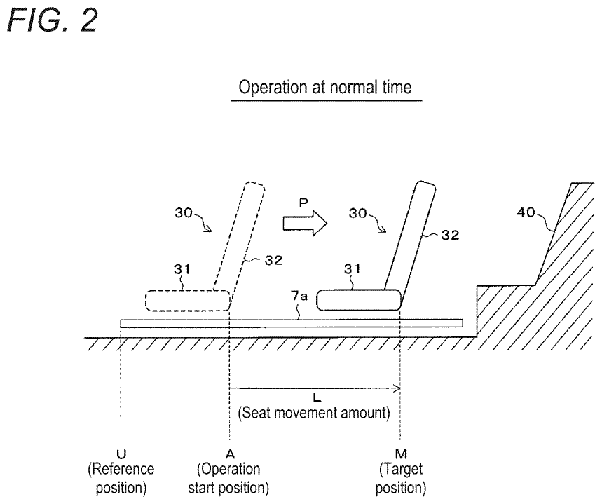

Next, an operation of the above-described electric seat system 100 will be described with reference to FIGS. 2 to 4.

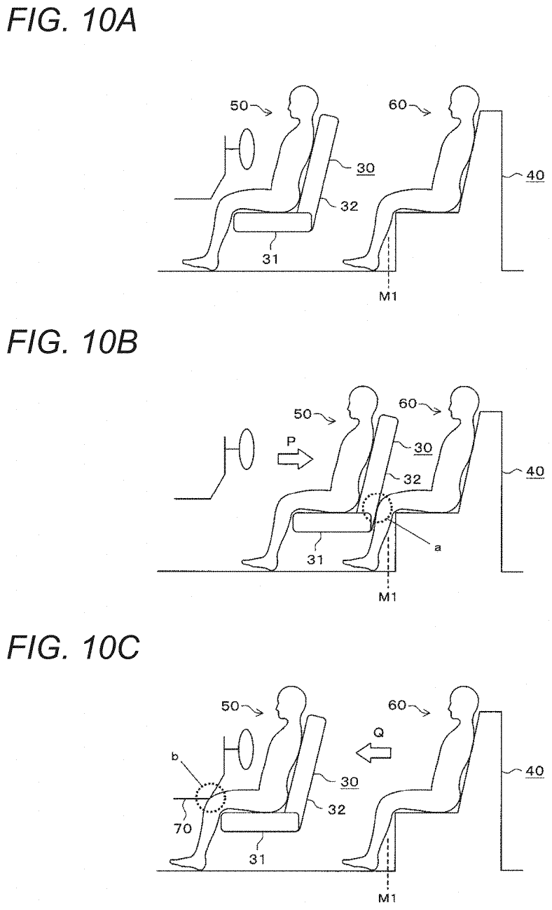

FIG. 2 illustrates an operation in a normal state in which no pinching occurs. The seat 30 in FIG. 2 is the same as the seat 30 in FIGS. 10A to 10C, and includes a seat portion 31 capable of moving straight forward and backward, and a backrest portion 32 connected to the seat portion 31. In the following description, pinching by straight movement of the seat portion 31 will be described as an example.

In FIG. 2, in an initial state before operation, the seat 30 is at a position indicated by a broken line. The position of the seat 30 at this time is defined as an operation start position A. The operation start position A is expressed as a distance from the reference position U to the rear end of the seat portion 31. The reference position U is set at a left end position of a rail 7a that guides the movement of the seat 30. The rail 7a is provided in the slide mechanism 7 (FIG. 1) described above.

In this initial state, when the first switch 11 (FIG. 1) of the operation unit 1 is operated, the automatic driving is started, the motor 6 rotates forward, and the seat 30 moves in a P direction (rearward) toward the target position M while the seat portion 31 is guided by the rail 7a. As described above, the target position M is a position stored in advance in the target position memory 24, and is expressed as a distance from the reference position U. When the seat 30 moves to the target position M as indicated by the solid line, the forward rotation of the motor 6 stops, and the seat 30 automatically stops. At this time, the movement distance from the start to the stop of the operation of the seat 30, that is, the seat movement amount L is L=|A−M|.

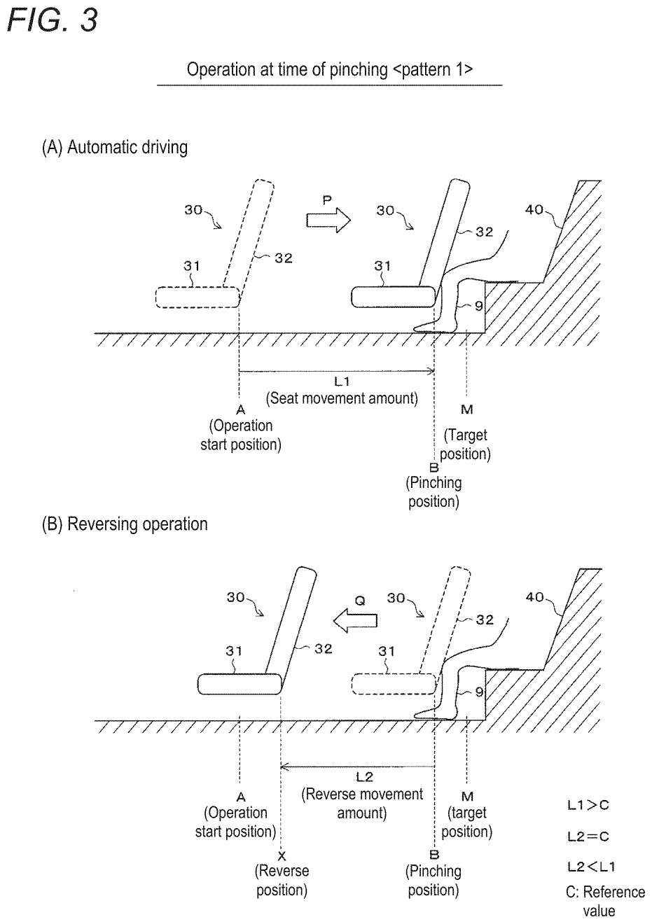

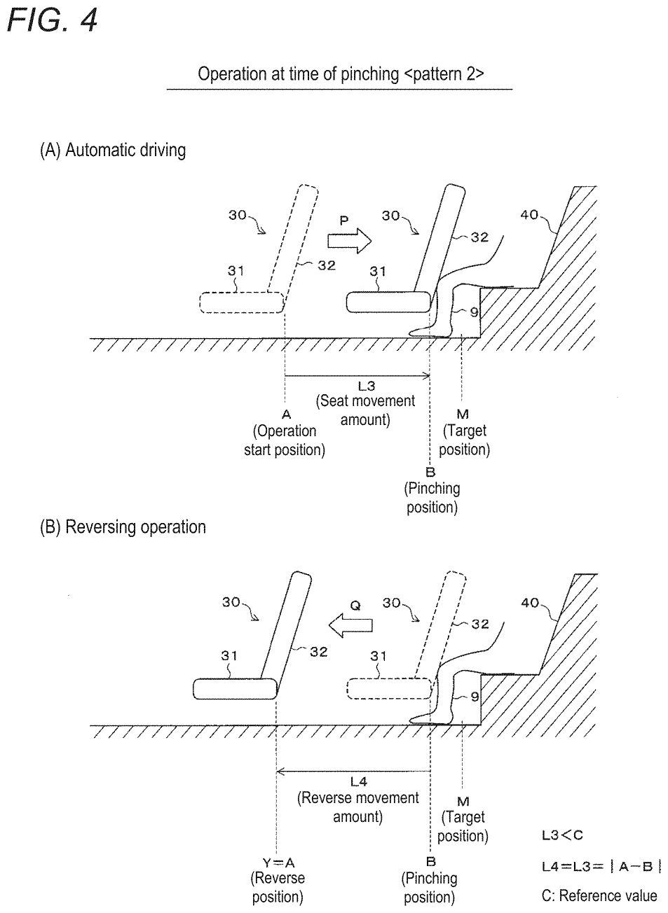

FIGS. 3 and 4 illustrate an operation example in a case where pinching occurs. FIG. 3 illustrates operations (Pattern 1) in a case where the distance from the operation start position of the seat to the pinching target is long, and FIG. 4 is an operation (Pattern 2) in a case where the distance from the operation start position of the seat to the pinching target is short. In the disclosure, these two patterns are selectively executed according to the seat movement amount.

First, Pattern 1 in FIG. 3 will be described. As shown in the diagram (A) of FIG. 3, when the seat 30 moves from the operation start position A in the P direction (rearward) and hits a leg 9 of the occupant seated on a rear seat 40 before reaching target position M, pinching occurs. Assuming that the position of the seat 30 at this time is a pinching position B, the movement distance of the seat 30, that is, the seat movement amount L1 is L1=|A−B|. In the case of Pattern 1, L1 is a value larger than a reference value C to be described later (L1>C). When the occurrence of pinching is detected by the pinching detector 22 (FIG. 1), the motor 6 temporarily stops and then rotates backward. Therefore, the seat 30 is reversed from the pinching position B as illustrated in the diagram (B) of FIG. 3 and moves in a Q direction (forward). As a result, the pinching of the leg 9 is eliminated.

When the reversely moved seat 30 reaches a reverse position X illustrated in the diagram (B) of FIG. 3, the reverse rotation of the motor 6 stops, and the seat 30 also stops at this position. Here, since the reverse position X is on the near side of the operation start position A in the Q direction, the seat 30 stops before reaching the operation start position A. The movement distance of the seat 30 from the pinching position B to the reverse position X, that is, a reverse movement amount L2 is L2=|X−B|, and the reverse movement amount L2 is a value equal to a predetermined reference value C (fixed value) (L2=C). Therefore, the relationship between the reverse movement amount L2 and the seat movement amount L1 is L2<L1.

As described above, in Pattern 1 of FIG. 3, when the seat movement amount L1 from the operation start position A to the pinching position B is larger than the reference value C (L1>C), the reverse movement amount L2 is limited to the reference value C so that the reverse movement amount L2 from the pinching position B to the reverse position X does not exceed the seat movement amount L1 (L2=C). Therefore, since the reversely moved seat 30 does not further move in the Q direction beyond the operation start position A, it is possible to avoid a situation in which pinching occurs again at another place as illustrated in FIG. 10C.

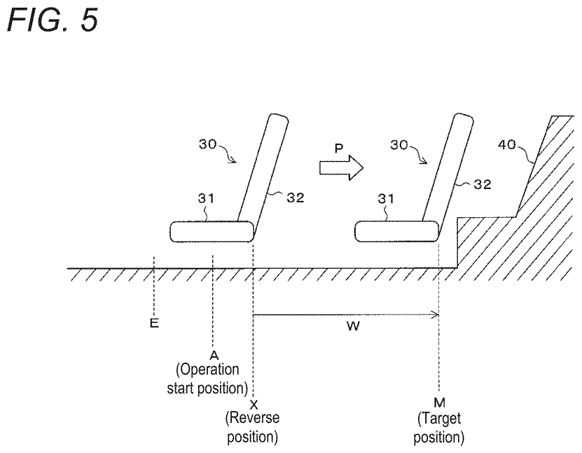

After the seat 30 stops at the reverse position X, the operator confirms that there is no person or object between the seats 30 and 40, and then operates the first switch 11 (FIG. 1) again to move the seat 30 from the reverse position X to the target position M as illustrated in FIG. 5. W represents the movement amount of the seat 30 at this time. In this case, since the reverse position X is in front of the operation start position A, the seat movement amount W becomes small as compared with the case where the reverse position exists at a position E exceeding the operation start position A, and the movement time of the seat 30 to the target position M can be shortened. The seat 30 may be manually moved from the reverse position X to the target position M by operating the second switch 12 instead of the first switch 11.

In the above description, the condition is that the seat movement amount L1 is larger than the reference value C (L1>C), but the seat movement amount L1 may be equal to the reference value C (L1=C). In this case, the reverse movement amount L2 becomes equal to the seat movement amount L1 (L2=L1=C), and the seat 30 that has reversely moved stops at the operation start position A. Therefore, since the seat 30 does not move beyond the operation start position A, it is possible to avoid the occurrence of pinching again at another place as in the above case. In addition, the movement time of the seat 30 to the target position M is shortened as compared with the case where the seat 30 stops beyond the operation start position A.

Next, Pattern 2 in FIG. 4 will be described. In the case of FIG. 4, as shown in the diagram (A) of FIG. 4, the operation start position A of the seat 30 is on the rear side as compared with FIG. 3, and the movement distance of the seat 30 from the operation start position A to the pinching position B, that is, the seat movement amount L3 (=|A−B|) is smaller than the reference value C (L3<C). Then, when pinching occurs, the seat 30 is reversed in the Q direction from the pinching position B as in the diagram (B) of FIG. 3 and then moved to the reverse position Y, which is the same position as the operation start position A (Y=A). That is, a reverse movement amount L4 of the seat 30 is the same as the seat movement amount L3 (L4=L3=|A−B|).

As described above, in Pattern 2, when the seat movement amount L3 from the operation start position A to the pinching position B is smaller than the reference value C (L3<C), the reverse movement amount L4 from the pinching position B to the reverse position Y is set to be equal to the seat movement amount L3, and the reverse movement amount L4 is limited to be less than the reference value C (L4<C). Therefore, since the reversely moved seat 30 does not further move in the Q direction beyond the operation start position A, it is possible to avoid the occurrence of pinching again at another place as in the case of Pattern 1.

After the seat 30 stops at the reverse position Y, the seat 30 is automatically or manually moved to the target position M in the same procedure as in Pattern 1 (see FIG. 5). Also in this case, since the reverse position Y does not exceed the operation start position A, the movement time of the seat 30 from the reverse position Y to the target position M can be shortened.

In FIG. 4, the reverse position Y is the same position as the operation start position A, but the reverse position Y may be a position slightly before the operation start position A. In this case, since the reversely moved seat 30 stops before the operation start position A, the seat does not move beyond the operation start position A, and it is possible to avoid the occurrence of pinching again at another place. In addition, the movement time of the seat 30 from the reverse position Y to the target position M is further shortened.

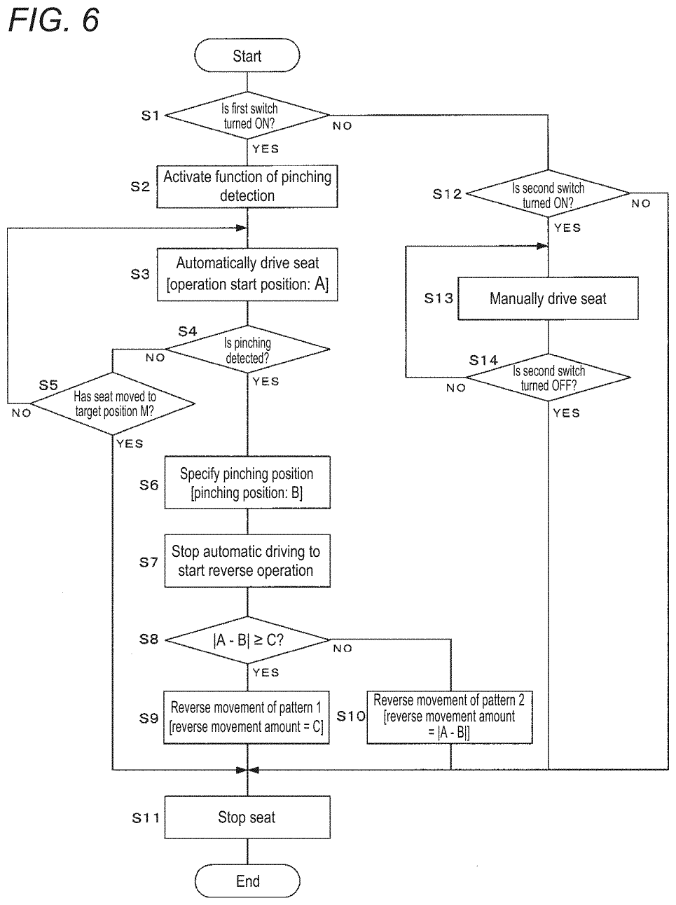

FIG. 6 is a flowchart illustrating a procedure in the seat control device 2 for executing the operations of Pattern 1 and Pattern 2 described above.

In Step S1, the motor controller 21 determines whether the first switch 11 of the operation unit 1 is turned on. If the first switch 11 is turned on (Step S1: YES), the process proceeds to Step S2 and subsequent steps in order to automatically drive the seat. In Step S2, the function of pinching detection by the pinching detector 22 is activated.

In the subsequent Step S3, under the control of the motor controller 21, the motor drive circuit 3 operates, the motor 6 rotates forward, and the automatic driving of the seat is started. Thus, the seat 30 moves from the operation start position A toward the target position M. Meanwhile, in Step S4, the pinching detector 22 detects the presence or absence of pinching. In Step S5, the motor controller 21 monitors whether the seat 30 has moved to the target position M based on the seat movement amount calculated by the seat movement amount calculator 23.

When pinching has not been detected (Step S4: NO) and the seat 30 has not reached the target position M (Step S5: NO), the automatic driving in Step S3 is continued. Then, when the seat 30 reaches the target position M (Step S5: YES) without pinching being detected (Step S4: NO), the process proceeds to Step S11. In Step S11, the motor controller 21 stops the motor 6, whereby the seat 30 is also stopped.

On the other hand, when pinching is detected before the seat 30 reaches the target position M (Step S4: YES), the process proceeds to Step S6. In Step S6, the motor controller 21 specifies the pinching position B based on the seat movement amount calculated by the seat movement amount calculator 23. Subsequently, in Step S7, the motor controller 21 temporarily stops the automatic drive by the forward rotation of the motor 6, and then rotates the motor 6 backward to start the seat reversing operation. As a result, the seat 30 is reversed at the pinching position B and moves in the reverse direction (the Q direction illustrated in FIG. 3 and the like).

Next, in Step S8, the motor controller 21 compares the seat movement amount |A−B| (L1 in FIG. 3, L3 in FIG. 4) calculated by the seat movement amount calculator 23 with the reference value C. As a result of the comparison, if |A−B|≥C (Step S8: YES), the process proceeds to Step S9, and if |A−B|<C (Step S8: NO), the process proceeds to Step S10.

In Step S9, the motor controller 21 executes the reverse movement of Pattern 1 in FIG. 3. In this case, when the determination result in Step S8 is |A−B|>C (that is, L1>C), the seat 30 reversed at the pinching position B moves to the reverse position X before the operation start position A. If the determination result in Step S8 is |A−B|=C (that is, L1=C), the seat 30 reversed at the pinching position B moves to the operation start position A. In either case, the reverse movement amount L2 of the seat 30 is L2=C as described above.

On the other hand, in Step S10, the motor controller 21 executes the reverse movement of Pattern 2 in FIG. 4. That is, the seat 30 reversed at the pinching position B moves to the same reverse position Y as the operation start position A. The reverse movement amount L4 at this time is L4=|A−B| as described above.

When the seat 30 moves to a predetermined reverse position in Steps S9 and S10, the process proceeds to Step S11, the motor 6 stops, and the seat 30 also stops.

If the first switch 11 is not turned on in Step S1 (Step S1: NO), the motor controller 21 determines whether the second switch 12 is turned on in Step S12. If the second switch 12 is turned on (Step S12: YES), the process proceeds to Step S13, and the seat 30 is manually driven under the control of the motor controller 21. This manual driving is continued while the second switch 12 is turned on (Step S14: NO). When the second switch 12 is turned off (Step S14: YES), the motor controller 21 stops the motor 6 in order to cancel the manual driving, and stops the seat 30 (Step S11).

After the seat 30 moved to the reverse position in Steps S9 and S10 is stopped in Step S11, the seat 30 is automatically or manually moved to the target position M as described above. In the automatic case, by turning on the first switch 11 again, Steps S1 to S11 are executed, and the seat 30 moves to the target position M by automatic driving. In the manual operation, by turning on the second switch 12, Steps S12 to S14 and S11 are executed, and the seat 30 is moved to the target position M by manual driving.

As described above, in the embodiment described above, when the seat 30 is interposed between the operation start position A and the target position M, if the seat movement amount L1 is equal to or larger than the reference value C as illustrated in FIG. 3, the reference value C is set as the reverse movement amount L2, and the seat 30 is moved in the reverse direction from the pinching position B (Pattern 1). On the other hand, when the seat movement amount L3 is less than the reference value C as illustrated in FIG. 4, the seat 30 is moved in the reverse direction from the pinching position B with the seat movement amount L3 as the reverse movement amount L4 (Pattern 2).

In this way, since the reverse movement amounts L2 and L4 are limited so that the seat 30 reversed at the pinching position B does not move beyond the operation start position A, it is possible to avoid the occurrence of pinching at another place by the seat 30 after the reverse. Further, since the seat 30 after the reverse stops at a position not exceeding the operation start position A, it is possible to shorten the time for moving the seat 30 from the position to the target position M.

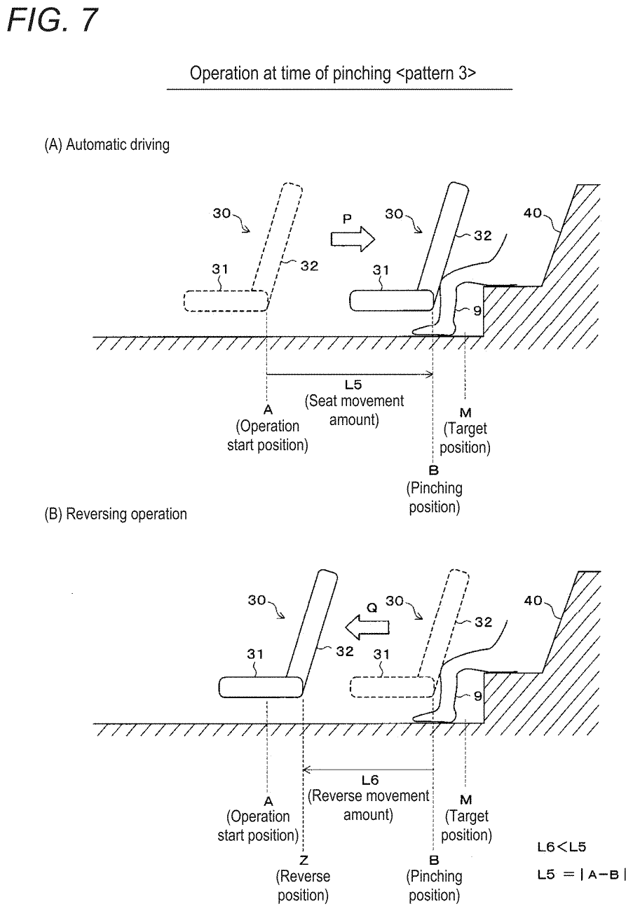

Next, another operation example (Pattern 3) in a case where pinching occurs will be described with reference to FIG. 7.

In the case of FIGS. 3 and 4, the seat movement amount (L1, L3) from the operation start position A to the pinching position B is compared with the reference value C, and the reverse movement amount (L2, L4) is determined according to the result. On the other hand, in the case of FIG. 7, the seat movement amount L5 illustrated in the diagram (A) of FIG. 7 is not compared with the reference value C. Regardless of the magnitude of the seat movement amount L5, a reverse movement amount L6 illustrated in the diagram of (B) of FIG. 7 is always set to a value smaller than the seat movement amount L5 (L6<L5). Therefore, the seat 30 reversed at the pinching position B always stops at a reverse position Z located before the operation start position A.

Also in such Pattern 3, the reversely moved seat 30 stops before reaching the operation start position A, and does not exceed the operation start position A. Therefore, similarly to the case of Patterns 1 and 2, it is possible to avoid occurrence of pinching again at another place. Further, since the reverse position Z is located before the operation start position A, the moving time of the seat 30 from the reverse position Z to the target position M can be shortened.

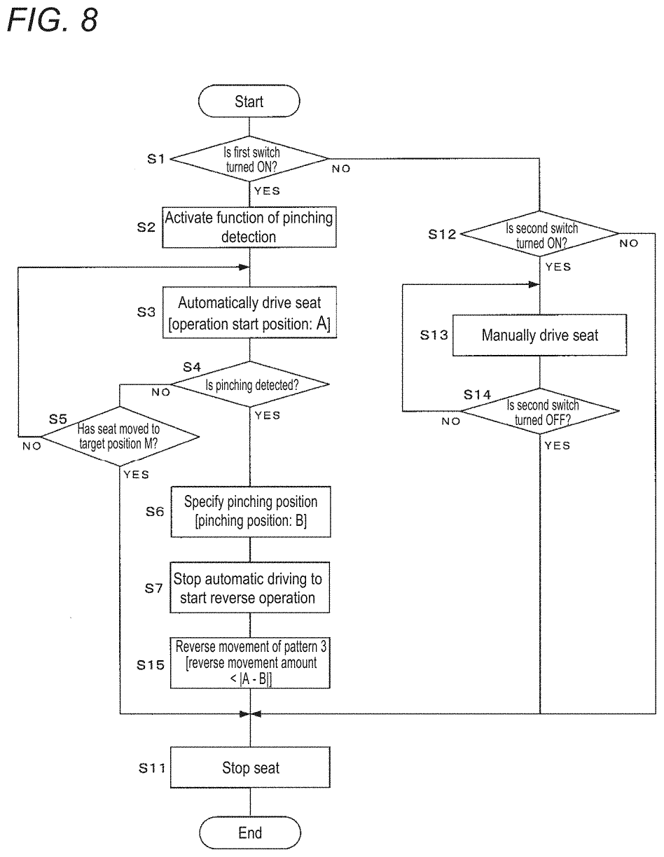

FIG. 8 is a flowchart illustrating a procedure in the seat control device 2 for executing the operation of Pattern 3 described above. In FIG. 8, the same reference numerals are given to steps that perform the same processing as in FIG. 6.

FIG. 8 differs from FIG. 6 in that Steps S8, S9, and S10 in FIG. 6 are replaced with Step S15. Since the others are the same as those in FIG. 6, the description of steps overlapping with those in FIG. 6 will be omitted.

In Step S15 of FIG. 8, the reverse movement of Pattern 3 is executed, and the seat 30 reversed at the pinching position B moves to the reverse position Z as illustrated in the diagram (B) of FIG. 7. Since the reverse movement amount L6 at this time is smaller than the seat movement amount L5 (=|A−B|) as described above, the seat 30 always stops before the operation start position A in Step S11.

When FIG. 8 is compared with FIG. 6, since the three Steps S8, S9, and S10 of FIG. 6 are replaced with one Step S15 in FIG. 8, it can be seen that the procedure of FIG. 8 simplifies the processing in the seat control device 2.

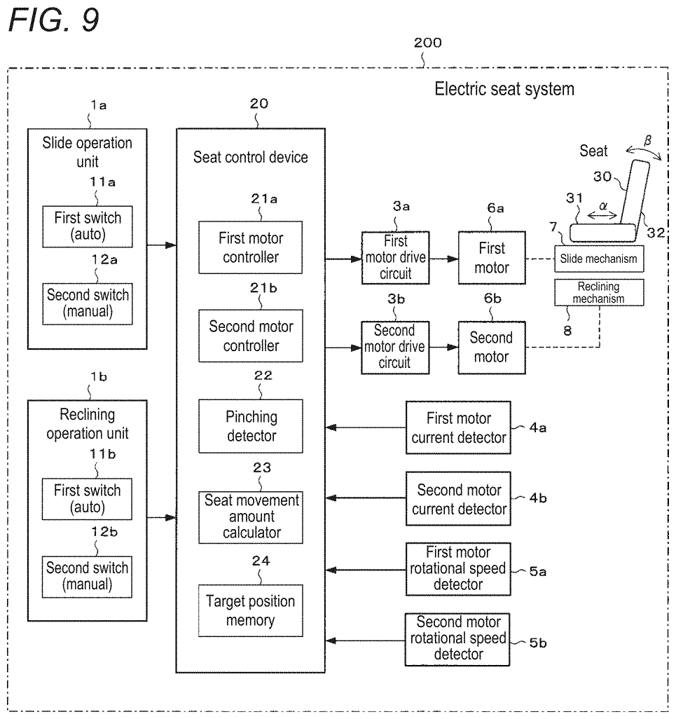

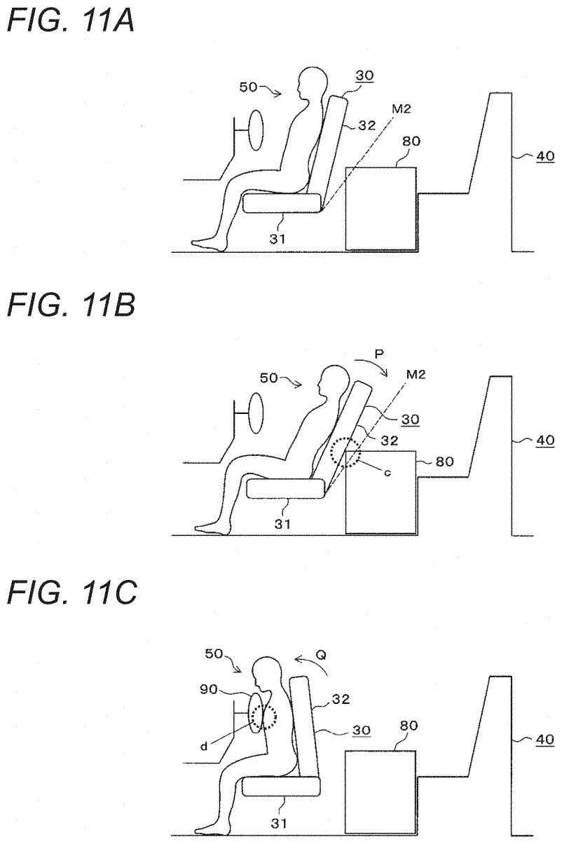

In the above embodiment, the pinching by the movement of the seat portion 31 has been described as an example, but the disclosure can also be applied to a case where the pinching by the inclination of the backrest portion 32 as described with reference to FIGS. 11A to 11C occurs. An embodiment in this case is illustrated in FIG. 9.

FIG. 9 is an example of a seat control device 20 according to a second embodiment of the disclosure and an electric seat system 200 using the same. In FIG. 9, the operation unit 1 in FIG. 1 is replaced with a slide operation unit 1a and a reclining operation unit 1b. The slide operation unit 1a′ includes a first switch 11a for automatically driving the seat portion 31 and a second switch 12a for manually driving the seat portion 31. The reclining operation unit 1b includes a first switch 11b for automatically driving the backrest portion 32 and a second switch 12b for manually driving the backrest portion 32.

In FIG. 9, in the seat control device 20, the motor controller 21 in FIG. 1 is replaced with a first motor controller 21a and a second motor controller 21b, the motor drive circuit 3 in FIG. 1 is replaced with a first motor drive circuit 3a and a second motor drive circuit 3b, and the motor 6 in FIG. 1 is replaced with a first motor 6a and a second motor 6b. The motor current detector 4 in FIG. 1 is replaced with a first motor current detector 4a and a second motor current detector 4b, and motor rotational speed detector 5 in FIG. 1 is replaced with a first motor rotational speed detector 5a and a second motor rotational speed detector 5b.

Further, in FIG. 9, a reclining mechanism 8 is provided in addition to the slide mechanism 7. The first motor 6a moves the seat portion 31 of the seat 30 straight in the a direction via the slide mechanism 7. The second motor 6b inclines the backrest portion 32 of the seat 30 in the 1 direction via the reclining mechanism 8.

In FIG. 9, the pinching detector 22 individually detects pinching by the seat portion 31 and pinching by the backrest portion 32. Further, the seat movement amount calculator 23 individually calculates the movement amount (distance) of the seat portion 31 and the movement amount (angle) of the backrest portion 32. Further, the target position memory 24 individually stores a target position (distance) of the seat portion 31 and a target position (angle) of the backrest portion 32.

In the second embodiment, the operation when the pinching occurs by the seat portion 31 is the same as the operation in the first embodiment (FIGS. 3 to 8). In addition, the operation in a case where pinching occurs by the backrest portion 32 is basically the same as the operation in the case of pinching by the seat portion 31 except that the movement amount and the position of the backrest portion 32 are represented by an inclination angle instead of a distance, and can be easily analogized from the first embodiment, and thus detailed description will be omitted.

In the disclosure, in addition to the embodiments described above, various embodiments described below can be adopted.

In the above embodiment, after the seat 30 moves from the pinching position B to the reverse positions X, Y, and Z and stops, the first switch 11 or the second switch 12 is operated to move the seat 30 to the target position M (FIG. 5), but the disclosure is not limited thereto. For example, the seat 30 may automatically move to the target position M without requiring operation of the switches 11 and 12 after a lapse of a certain time from a point of time when the seat 30 stops at the reverse positions X, Y, and Z.

In the above embodiment, the automatic driving of the seat 30 is started by operating the first switch 11. Alternatively, the automatic driving of the seat 30 may be started based on communication with an electronic key used for locking or unlocking a door.

In the above embodiment, the pinching is detected based on the motor current detected by the motor current detector 4. Alternatively, the pinching may be detected based on the rotational speed of the motor 6 detected by the motor rotational speed detector 5.

In the above embodiment, the motor drive circuit 3 is provided outside the seat control device 2 in FIG. 1, but the motor drive circuit 3 may be included in the seat control device 2. The motor current detector 4 and the motor rotational speed detector 5 may also be included in the seat control device 2.

In the above embodiment, the seat control device mounted on the vehicle has been described as an example, but the disclosure can also be applied to seat control devices used in fields other than the vehicle.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A seat control device having a function of automatically moving an electric seat moved by rotation of a motor from an operation start position to a target position, the seat control device comprising:
a pinching detector configured to detect pinching of an object while the seat is moving to the target position; and
a motor controller configured to rotate the motor forward to move the seat to the target position, and when the pinching detector detects pinching of the object, rotate the motor backward to move the seat by a predetermined reverse movement amount in a reverse direction from a pinching position where the pinching has occurred,
wherein, when a seat movement amount from the operation start position to the pinching position is greater than or equal to a predetermined reference value, the reverse movement amount is the reference value, and
wherein, when the seat movement amount from the operation start position to the pinching position is less than the reference value, the reverse movement amount is the seat movement amount.

2. The seat control device according to claim 1, further comprising:
a first switch configured to be operated when the seat is automatically moved to the target position,
wherein the motor controller rotates the motor forward to move the seat to the target position based on operation of the first switch after the seat moves in the reverse direction and stops.

3. The seat control device according to claim 2, further comprising:
a second switch configured to be operated when the seat is manually moved,
wherein the motor controller rotates the motor forward based on the operation of the second switch after the seat moves in the reverse direction and stops, and moves the seat in a direction of the target position while the second switch is operated.

4. The seat control device according to claim 1,
wherein the seat is a seat having a seat portion capable of moving straight forward and backward, and
wherein the seat movement amount is a movement distance of the seat portion.

5. The seat control device according to claim 1,
wherein the seat is a seat having a backrest portion inclinable forward and backward, and
wherein the seat movement amount is an inclination angle of the backrest portion.

6. A seat control device having a function of automatically moving an electric seat moved by rotation of a motor from an operation start position to a target position, the seat control device comprising:
a pinching detector configured to detect pinching of an object while the seat is moving to the target position; and
a motor controller configured to rotate the motor forward to move the seat to the target position, and when the pinching detector detects pinching of the object, rotate the motor backward to move the seat by a predetermined reverse movement amount in a reverse direction from a pinching position where the pinching has occurred,
wherein the reverse movement amount is a value smaller than a seat movement amount from the operation start position to the pinching position, and
wherein the motor controller stops the seat moving in a reverse direction before reaching the operation start position.

7. The seat control device according to claim 6, further comprising:
a first switch configured to be operated when the seat is automatically moved to the target position,
wherein the motor controller rotates the motor forward to move the seat to the target position based on operation of the first switch after the seat moves in the reverse direction and stops.

8. The seat control device according to claim 7, further comprising:
a second switch configured to be operated when the seat is manually moved,
wherein the motor controller rotates the motor forward based on the operation of the second switch after the seat moves in the reverse direction and stops, and moves the seat in a direction of the target position while the second switch is operated.

9. The seat control device according to claim 6,
wherein the seat is a seat having a seat portion capable of moving straight forward and backward, and
wherein the seat movement amount is a movement distance of the seat portion.

10. The seat control device according to claim 6,
wherein the seat is a seat having a backrest portion inclinable forward and backward, and
wherein the seat movement amount is an inclination angle of the backrest portion.

11. A seat control method for automatically moving an electric seat that moves by rotation of a motor from an operation start position to a target position, the seat control method comprising:
rotating the motor forward to move the seat to the target position;
detecting that the seat pinches an object while moving to the target position; and
rotating the motor backward and moving the seat by a predetermined reverse movement amount in a reverse direction from a pinching position where pinching has occurred when the pinching of the object is detected,
wherein, when a seat movement amount from the operation start position to the pinching position is greater than or equal to a predetermined reference value, the reverse movement amount is the reference value, and
wherein, when the seat movement amount from the operation start position to the pinching position is less than the reference value, the reverse movement amount is the seat movement amount.

12. A seat control method for automatically moving an electric seat that moves by rotation of a motor from an operation start position to a target position, the seat control method comprising:
rotating the motor forward to move the seat to the target position;
detecting that the seat pinches an object while moving to the target position;
rotating the motor backward and reversing the seat in a reverse direction from a pinching position where pinching has occurred when the pinching of the object is detected; and
moving the reversed seat by a reverse movement amount smaller than a seat movement amount from the operation start position to the pinching position.
